(19) United States
(12) Patent Application Publication
(10) Pub. No.: US 2025/0191151 A1
(43) Pub. Date: Jun. 12, 2025

(54) METHODS AND SYSTEMS FOR GENERATING SUGGESTIONS TO ENHANCE ILLUMINATION IN A VIDEO STREAM

(71) Applicant: SAMSUNG ELECTRONICS CO., LTD., Suwon-si (KR)

(72) Inventors: Vipul GUPTA, Hisar (IN); Vaibhav NEGI, Jaipur (IN); Nitesh GOYAL, Ghaziabad (IN)

(73) Assignee: SAMSUNG ELECTRONICS CO., LTD., Suwon-si (KR)

(21) Appl. No.: 18/978,897

(22) Filed: Dec. 12, 2024

Related U.S. Application Data
(63) Continuation of application No. PCT/KR2024/018253, filed on Nov. 19, 2024.

(30) Foreign Application Priority Data
Dec. 12, 2023 (IN) 202311084798

(51) Int. Cl. G06T 5/90; G06T 3/40; G06T 7/70; G08B 6/00

(52) U.S. Cl. CPC G06T 5/90; G06T 3/40; G06T 7/70; G08B 6/00

(57) ABSTRACT

Disclosed are a method and system for generating suggestions to enhance illumination in a video stream including receiving one or more image frames corresponding to the video stream, identifying, based on the one or more image frames corresponding to the video stream, an object in focus and a corresponding position of the object, identifying one or more light characteristics surrounding the identified object in focus to identify a position of at least one light source illuminating the identified object in focus, identifying one or more frame quality features associated with the video stream based on at least one of the position of the object in focus or the position of the at least one light source, and identifying one or more adjustment parameters corresponding to the one or more frame quality features for generating suggestions for the user to enhance illumination of the identified object in focus in the video stream.

### CROSS-REFERENCE TO RELATED APPLICATION(S)

This application is a continuation of International Application No. PCT/KR2024/018253, filed on Nov. 19, 2024, in the Korean Intellectual Property Receiving Office and claiming priority to Indian Priority patent application No. 202311084798 filed on Dec. 12, 2023, in the Indian National Intellectual Property Administration, the disclosures of each of which are incorporated by reference herein in their entireties.

### BACKGROUND

### 1. Field

The disclosure relates to video streams, and more specifically relates to methods and systems for generating suggestions to enhance illumination in a video stream.

### 2. Description of Related Art

The emergence of video streaming, particularly in video calling, has revolutionized communication, bringing people closer irrespective of geographical distances. In the video calling, how users perceive each other during such video calls greatly affects user experience. In the context of the video calling, a user requirement is optimization of visual representations of the users, emphasizing the desire for the presentation of their best features during the communication session. During the video calls, atmospheric lighting conditions and angles can play a significant role in affecting the quality of a video during a video call, mainly intensity, quality, and direction of light, which can significantly enhance a video frame and help the users to display their best features.

However, related art video streaming solutions fail to utilize the above-mentioned information about the light, and therefore fail to provide the best user experience during such video streaming sessions. Specifically, when the position of the light source changes, the light illumination on the face of the user changes. Thus, if the user changes his/her position with respect to the light source, the light illumination on the face will change. However, the video streaming solutions fail to take the above aspects into consideration while generating video streams. Moreover, the user is mostly unaware of the proper use of background lighting condition and sometimes prefer using external light sources, which might be expensive and cumbersome.

In some scenarios, the lighting conditions affect the video stream in such a way that it becomes difficult to effectively conduct the video session. Thus, a bad lighting condition may significantly affect the user experience of the video session.

Also, in some scenarios, a user capturing the video does not have access to a display screen of a device displaying the video. Thus, it becomes difficult for the user to view an output during the video session and enhance the quality of the video stream.

Some related art video streaming solutions try to enhance the light illumination in video frames by causing intervention in frame data. Specifically, such related art video streaming solutions enhance/rectify illumination-based distortion in the video frames by modifying the frame data. However, such related art video streaming solutions may cause network lagging due to large-size generative models used by such related art video streaming solutions. Moreover, the related art video streaming solutions require large-scale data consumption and calculation to modify/rectify the frame data.

Accordingly, there is a need to overcome at least the above challenges associated with related art techniques of generating a video stream.

### SUMMARY

Provided is a selection of concepts, in a simplified format, that are further described in the detailed description. This summary is neither intended to identify key concepts nor is it intended for determining the scope of the disclosure.

According to an aspect of the disclosure, there is provided a method for generating suggestions to enhance illumination in a video stream, the method including: receiving one or more image frames corresponding to the video stream; identifying, based on the one or more image frames corresponding to the video stream, an object in focus and a corresponding position of the object; identifying one or more light characteristics surrounding the identified object in focus to identify a position of at least one light source illuminating the identified object in focus; identifying one or more frame quality features associated with the video stream based on at least one of the position of the object in focus or the position of the at least one light source; and identifying one or more adjustment parameters corresponding to the one or more frame quality features for generating suggestions for the user to enhance illumination of the identified object in focus in the video stream.

The method may include receiving metadata associated with the video stream, wherein the metadata indicates a context of the video stream; assigning a priority to each of the one or more frame quality features based on the received metadata; and identifying the one or more adjustment parameters to enhance the one or more frame quality features based on the assigned priority of each of the one or more frame quality features.

The metadata may include at least one of a purpose of the video stream, an identity of the user, a relation of the user with another user captured in the video stream, a time of the video stream, or a location of the video stream.

The one or more frame quality features may include at least one of a contrast, an intensity, a quality, or a direction of a camera device capturing the video stream.

The method may include identifying whether the user of a camera device used for capturing the video stream views a display of the camera device based at least on a relative position of the camera device and the object in focus; based on identifying that the user views the display of the camera device, displaying the generated suggestions on a display interface associated with the camera device; and based on identifying that the user is unable to view the display of the camera device, generating non-visual indicators corresponding to the generated suggestions.

The non-visual indicators may include at least one of tactic feedbacks or vibration patterns.

The identifying the position of the at least one light source illuminating the identified object in focus may include: scaling the identified object in focus based on a reference object stored in a database; applying a shape mask on the object in focus based on the reference object; normalizing at least one frame among the one or more image frames based on the scaled and masked object in focus; generating a pixel scattering matrix based on the normalized at least one frame, wherein the pixel scattering matrix indicates distribution of the at least one light source illuminating the identified object in focus; and identifying the position of the at least one light source illuminating the identified object in focus based on the generated pixel scattering matrix.

The one or more adjustment parameters may include at least one of a path calibration, a rotation calibration, or a head calibration, wherein the path calibration corresponds to a change in at least one of a longitudinal and latitude direction of a camera device capturing the video stream, a rotation calibration corresponds to a degree of horizontal rotation of the camera device, or a head calibration corresponds to a degree of vertical rotation of the camera device.

The one or more light characteristics may include an intensity and a direction of light on the identified object of focus.

According to an aspect of the disclosure, there is provided a system for generating suggestions to enhance illumination in a video stream including: a memory storing instructions; and at least one processor, wherein the instructions, when executed by the at least one processor, cause the system to: receive one or more image frames corresponding to the video stream; identify, based on the one or more image frames corresponding to the video stream, an object in focus and a corresponding position; identify one or more light characteristics surrounding the identified object in focus to identify a position of at least one light source illuminating the identified object in focus; identify one or more frame quality features associated with the video stream based at least one of the position of the object in focus or the position of the at least one light source; and identify one or more adjustment parameters corresponding to the one or more frame quality features for generating suggestions for the user to enhance illumination of the identified object in focus in the video stream.

The instructions, when executed by the at least one processor, may cause the system to: receive metadata associated with the video stream, wherein the metadata indicates a context of the video stream; assign a priority to each of the one or more frame quality features based on the received metadata; and identify the one or more adjustment parameters to enhance the one or more frame quality features based on the assigned priority of each of the one or more frame quality features.

The metadata may include at least one of a purpose of the video stream, an identity of the user, a relation of the user with another user captured in the video stream, a time of the video stream, and a location of the video stream.

The one or more frame quality features may include at least one of a contrast, an intensity, a quality, or a direction of a camera device capturing the video stream.

The instructions, when executed by the at least one processor, may cause the system to: identify whether the user of a camera device used for capturing the video stream views a display of the camera device based at least on a relative position of the camera device and the object in focus; based on identifying that the user views the display of the camera device, display the generated suggestions on a display interface associated with the camera device; and based on identifying that the user is unable to view the display of the camera device, generate non-visual indicators corresponding to the generated suggestions.

The non-visual indicators may include at least one of tactic feedbacks or vibration patterns.

To identify the position of the at least one light source illuminating the identified object in focus, the at least one processor may be configured to: scale the identified object in focus based on a reference object stored in a database; apply a shape mask on the object in focus based on the reference object; normalize at least one frame among the one or more image frames based on the scaled and masked object in focus; generate a pixel scattering matrix based on the normalized at least one frame, wherein the pixel scattering matrix indicates distribution of the at least one light source illuminating the identified object in focus; and identify the position of the at least one light source illuminating the identified object in focus based on the generated pixel scattering matrix.

The one or more adjustment parameters may include at least one of a path calibration, a rotation calibration, or a head calibration, wherein the path calibration corresponds to a change in at least one of a longitudinal and latitude direction of a camera device capturing the video stream, a rotation calibration corresponds to a degree of horizontal rotation of the camera device, or a head calibration corresponds to a degree of vertical rotation of the camera device.

The one or more light characteristics may include an intensity and a direction of light on the identified object of focus.

According to an aspect of the disclosure, there is provided an electronic device including: a memory storing instructions; and at least one processor, wherein the instructions, when executed by the at least one processor, cause the electronic device to: receive one or more image frames corresponding to the video stream; identify, based on the one or more image frames corresponding to the video stream, an object in focus and a corresponding position; identify one or more light characteristics surrounding the identified object in focus to identify a position of at least one light source illuminating the identified object in focus; identify one or more frame quality features associated with the video stream based at least one of the position of the object in focus or the position of the at least one light source; and identify one or more adjustment parameters corresponding to the one or more frame quality features for generating suggestions for the user to enhance illumination of the identified object in focus in the video stream. 2

The instructions, when executed by the at least one processor, may cause the electronic device to: receive metadata associated with the video stream, wherein the metadata indicates a context of the video stream; assign a priority to each of the one or more frame quality features based on the received metadata; and identify the one or more adjustment parameters to enhance the one or more frame quality features based on the assigned priority of each of the one or more frame quality features.

According to an aspect of the disclosure, there is provided o ne or more non-transitory computer-readable storage media storing one or more computer programs including computer-executable instructions that, when executed by at least one processor, cause a system to perform operations. The operations comprises: receiving one or more image frames corresponding to the video stream; identifying, based on the one or more image frames corresponding to the video stream, an object in focus and a position of the object in focus; identifying a position of at least one light source illuminating the identified object in focus by identifying one or more light characteristics surrounding the object in focus; identifying one or more frame quality features associated with the video stream based on at least one of the position of the object in focus or the position of the at least one light source; and identifying one or more adjustment parameters corresponding to the one or more frame quality features for generating suggestions for the user to enhance illumination of the identified object in focus in the video stream.

### BRIEF DESCRIPTION OF THE DRAWINGS

These and other features and/or aspects of the disclosure will become better understood when the following detailed description is read with reference to the accompanying drawings in which:

FIG. 1 illustrates a schematic workflow of a system for generating suggestions to enhance illumination in a video stream, according to an embodiment of the disclosure;

FIG. 2 illustrates a schematic block diagram of the system for generating suggestions to enhance illumination in the video stream, according to an embodiment of the disclosure;

FIG. 3 illustrates a schematic block diagram of an atmospheric light sensing unit of the system, according to an embodiment of the disclosure;

FIG. 4 illustrates a schematic block diagram of a relative direction calibrator unit of the system, according to an embodiment of the disclosure;

FIG. 5 illustrates an operation of a path calibration module of the relative direction calibrator unit, according to an embodiment of the disclosure;

FIG. 6 illustrates an operation of a rotation calibration module of the relative direction calibrator unit, according to an embodiment of the disclosure;

FIG. 7 illustrates an operation of a head calibration module of the relative direction calibrator unit, according to an embodiment of the disclosure;

FIG. 8 illustrates a schematic block diagram of a screen adjustment guide unit of the system, according to an embodiment of the disclosure;

FIG. 9 illustrates a schematic block diagram of a vibration adjustment guide unit of the system, according to an embodiment of the disclosure;

FIG. 10 illustrates some example vibration patterns corresponding to different adjustment parameters, according to one or more embodiments of the disclosure.

FIG. 11 illustrates a flow chart of a method for generating suggestions to enhance illumination in a video stream, according to an embodiment of the disclosure; and

FIGS. 12A and 12B illustrate an example scenario of the implementation of the system during a video call, according to one or more embodiments of the disclosure.

Further, skilled artisans will appreciate that elements in the drawings may not have necessarily been drawn to scale. For example, the flow charts illustrate the method in terms of the most prominent operations involved to help improve understanding of aspects of the disclosure. Furthermore, in terms of the construction of the device, one or more components of the device may have been represented in the drawings by conventional symbols, and the drawings may show only those details that are useful to understanding the embodiments so as not to obscure the drawings with details that will be readily apparent to those of ordinary skill in the art having the benefit of the description herein.

### DETAILED DESCRIPTION

Reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles as illustrated therein being contemplated as would normally occur to one skilled in the art to which the disclosure relates.

It will be understood by those skilled in the art that the foregoing general description and the following detailed description are explanatory and are not intended to be restrictive thereof.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

Reference throughout this disclosure to “an aspect”, “another aspect” or similar language means that a particular feature, structure, or characteristic described in connection with an embodiment is included in at least one embodiment. Thus, appearances of the phrase “in an embodiment”, “in another embodiment” and similar language throughout this disclosure may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The terms “illumination source” and “light source” may be used interchangeably throughout the disclosure.

Embodiments of the disclosure are directed towards a method and a system for generating suggestions to enhance illumination in a video stream. A key objective of the disclosure is to provide physical adjustment parameters (such as a change of position, a change of angle, etc.) to a user based on their personalized preferences during a video call so that the user can best utilize the atmospheric light to get desired video frames during the video call. Further, the disclosure uses one or more artificial intelligence (AI) models that utilize a relative positioning of “an object in focus”, “an illumination source”, and “a camera device” to provide adjustment parameters like path movement, camera rotation, and tilt adjustment so that the video frames are generated as per the user's preference. The method includes analyzing the position of the illumination source in relation to the position of the camera device (i.e., the user device 102) in view of the object in focus, to distinguish the illumination source as a front light, a side light, or a backlight. Based on said distinction, the method includes generating suggestions for the user to change the relative positioning of the illumination source and camera device, i.e., whether the user should move closer or farther from the camera device and/or the illumination source.

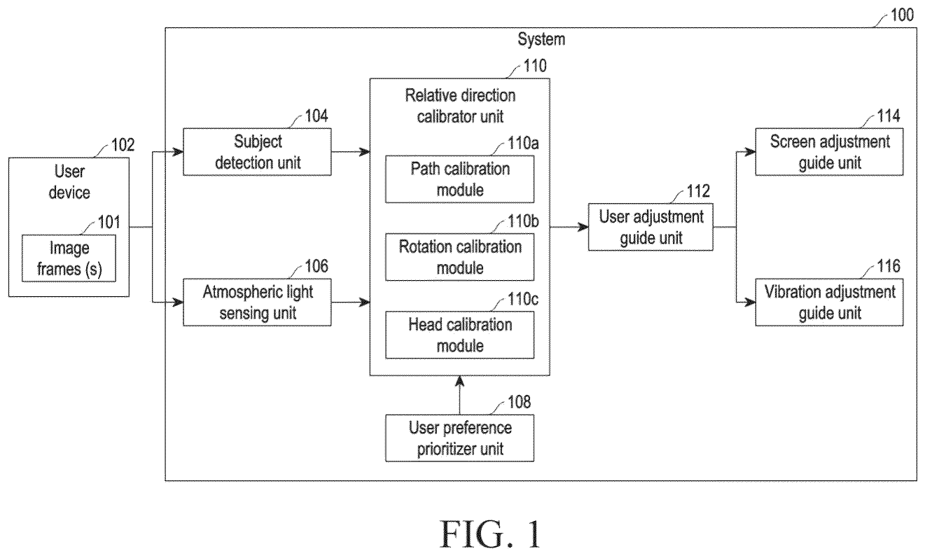

FIG. 1 illustrates a schematic workflow of a system 100 for generating suggestions to enhance illumination in a video stream, according to an embodiment of the disclosure. In one embodiment, the system 100 may be a standalone entity that is communicably coupled to user device 102. In another embodiment, the system 100, either in-part or as a whole, may be implemented at the user device 102. Examples of the user device 102 may include, but are not limited to, a smartphone, a tablet, a portable computing device, a camera, a digital video recorder, and/or any other camera device. The user device 102 may be configured to capture and generate a video stream including a plurality of image frames 101. The video stream may correspond to a video calling session, a video blog, and so forth. The user device 102 may be configured to share the generated video stream and/or the plurality of image frames 101 to the system 100 in real-time. In one embodiment, the system 100 may be communicably coupled with the user device 102 via a network. The system 100 may be configured to receive and process the video stream and/or the plurality of image frames 101 in real-time for generating suggestions to enhance illumination in the video stream.

The system 100 may include a subject detection unit 104, an atmospheric light sensing unit 106, a user preference prioritizer unit 108, a relative direction calibrator unit 110, a user adjustment guide unit 112, a screen adjustment guide unit 114, and/or a vibration adjustment guide unit 116. The subject detection unit 104 may be configured to receive the video stream and/or the one or more image frames 101 corresponding to the video stream from the user device 102, as input. The subject detection unit 104 may be configured to utilize one or more AI models to detect at least one object in focus in the video stream and/or the one or more image frames. In one embodiment, the subject detection unit 104 may identify a person from a group of people as the object in focus. In another embodiment, the subject detection unit 104 may consider the whole group of people as the object in focus. In alternative embodiments, the subject detection unit 104 may also consider an object as the object in focus. Specifically, the phrase “object in focus” may include any object and/or an entity including a person or a group of people that is the focus of the video stream. For instance, in a video calling scenario, the person who has initiated the call may be considered as the object in focus (may also referred to as “person in focus”), whereas in an advertisement video shoot a product (for example, a cosmetic product, an electronic appliance, etc.) may be considered as the object in focus. In one embodiment, the subject detection unit 104 may be configured to perform operations such as, but not limited to, frame extraction, object localization, feature extraction, subject tracking, subject classification, etc., to perform identifying the object in focus. In some embodiments, the subject detection unit 104 may also identify a position of the identified object in focus in a 2-dimensional (2D) and/or a 3-dimension (3D) space. In some embodiment, the subject detection unit 104 may also be configured to analyze one or more visual parameters corresponding to the object in focus. Such one or more visual parameters may include, but are not limited to, an intensity, a contrast, a brightness, a shadow, and so forth.

The atmospheric light sensing unit 106 may be configured to receive and process the video stream and/or the plurality of image frames corresponding to the video stream to extract information related to at least an intensity and a direction of one or more light sources that illuminate the surrounding of the object in focus. The one or more light sources may include both natural light sources (for example, sunlight) and artificial light sources (for example, an electric bulb). Also, the atmospheric light sensing unit 106 may be configured to identify the position of each of the one or more light sources based on the extracted information. In some embodiments, the atmospheric light sensing unit 106 may be configured to utilize one or more AI models to detect light characteristics such as, the intensity and the direction corresponding to the one or more light sources, and the corresponding positions of the one or more light sources.

In one embodiment, the user device 102 may also share metadata associated with the video stream and/or the plurality of image frames 101, with the system 100. The metadata may include information such as, but not limited to, the purpose of the video stream, a relation of the caller-callee in case the video steam corresponds to a video call, a time of video stream, a location of the video stream, and so forth. The metadata may indicate the context of the video stream. The user preference prioritizer unit 108 may be configured to receive said metadata, as input. The user preference prioritizer unit 108 may be configured to process the received metadata to identify and prioritize the user's preferences for the video stream. The user preference prioritizer unit 108 may identify which feature of the video stream and/or the plurality of image frames 101 is most desired for the video stream. Examples of such features may include contrast, intensity, brightness, quality, etc. In an embodiment, the identified features may be referred to as frame quality features. The user preference prioritizer unit 108 may generate a list of the frame quality features along with a corresponding priority order and share with the relative direction calibrator unit 110. In one non-limiting example, if the user is capturing the video stream during the night, it is more likely that the user may be required to enhance the intensity of the illumination source/light source. Similarly, if a user is having a video call with his/her mother who is an elder lady with low visibility, the user may wish to enhance the contrast of the video stream and reduce glare from the video stream to have a good communication experience. In some embodiments, the metadata associated with the video stream may be identified by the user device 102 and/or the system 100 prior to the video stream and during an initial phase of the video stream. In one embodiment, the user device 102 may analyze user-related data and/or receive one or more user inputs to generate said metadata corresponding to the video stream.

The relative direction calibrator unit 110 may be communicably coupled with the subject detection unit 104, the atmospheric light sensing unit 106, and the user preference prioritizer unit 108. The relative direction calibrator unit 110 may be configured to take an output of each of the subject detection unit 104, the atmospheric light sensing unit 106, and the user preference prioritizer unit 108, as input. In an example embodiment, the relative direction calibrator unit 110 may be configured to utilize the received information related to the object in focus, the one or more light sources, and/or the user's preferences for the video stream, to predict one or more adjustments to enhance the video stream and/or the plurality of image frames 101. The relative direction calibrator unit 110 may be configured to identify a relative position of the object in focus, the user device 102, and/or the one or more light sources to predict one or more adjustments in the position of the object in focus and/or the camera device to enhance the video stream in accordance with the user's preference as identified by the user preference prioritizer unit 108. In one embodiment, the relative direction calibrator unit 110 may include a path calibration module 110a, a rotation calibration module 110b, and a head calibration module 110c. The path calibration module 110a may be configured to generate the one or more adjustment parameters in terms of longitude and/or latitude directions based on a relative distance between the camera device/user device 102 and/or the one or more light sources. The rotation calibration module 110b may be configured to generate the one or more adjustment parameters in terms of a degree of rotation of the camera device/user device 102 based on an angle of the one or more light sources with respect to the object in focus. The head calibration module 110c may be configured to generate the one or more adjustments such as, head adjustments/tilt adjustments for the object in focus and/or the camera device/user device 102.

The user adjustment guide unit 112 may be configured to receive the one or more adjustment parameters generated by the relative direction calibrator unit 110. The user adjustment guide unit 112 may communicate with the screen adjustment guide unit 114 and the vibration adjustment guide unit 116 to generate one or more suggestions for the user (i.e., a person capturing the video stream) to enhance the video stream. The user adjustment guide unit 112 may determine whether the user capturing the video stream may see a display screen of the camera device/user device 102 and decide whether to provide the one or more generated suggestions via the display screen or not. For instance, in a video calling session, a user who is holding the user device 102 has a view of the back side of the user device 102, whereas a front camera of the user device 102 is currently in use, therefore a visual suggestion to enhance the video stream may not be useful for the user. Based on the determination of whether the user capturing the video stream may view the display screen of the user device 102 or not, the user adjustment guide unit 112 may communicate with the screen adjustment guide unit 114 and/or the vibration adjustment guide unit 116. Upon determining that the user capturing the video stream may see the display screen of the user device 102, the user adjustment guide unit 112 may generate visual suggestions using the screen adjustment guide unit 114. However, upon determining that the user capturing the video stream cannot see the display screen of the user device 102, the user adjustment guide unit 112 may generate the suggestion as vibration patterns via the vibration adjustment guide unit 116.

The screen adjustment guide unit 114 may be configured to take the one or more adjustment parameters from the user adjustment guide unit 112, as input. Based on the received input, the screen adjustment guide unit 114 may be configured to display a user interface (may also be referred to as a navigation on-screen) to guide the user to adjust at least one of a distance, an angle of camera, or head movement in accordance with the one or more adjustment parameters and enhance the video stream being captured by the user. The user-interface may correspond to a picture-in-picture (PIP) overlay that enables the system 100 to provide the user with the one or more suggestions in accordance with the one or more adjustment parameters.

The vibration adjustment guide unit 116 may be configured to take the one or more adjustment parameters from the user adjustment guide unit 112, as input. Based on the received input, the vibration adjustment guide unit 116 may generate vibration patterns with different characteristics such as, but not limited to, displacement, velocity, and acceleration, in accordance with the one or more adjustment parameters. The vibration adjustment guide unit 116 may generate the vibration patterns in such a manner that the vibrations may guide the user to adjust at least one of the distance, the angle of the camera, or head movement in accordance with the one or more adjustment parameters and enhance the video stream. In one embodiment, the vibration adjustment guide unit 116 may communicate with a vibration motor of the user device 102 to generate the required vibration patterns. The vibration adjustment guide unit 116 may control the operation of the vibration motor of the user device 102 to generate the required vibration patterns and provide the desired suggestions to the user.

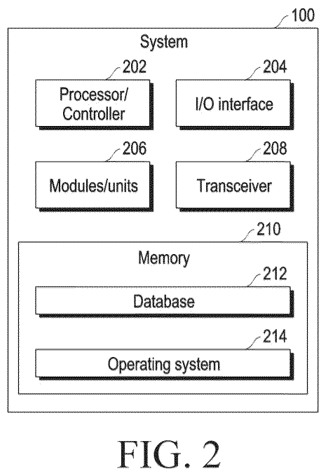

FIG. 2 illustrates a schematic block diagram of the system 100 for generating suggestions to enhance illumination in a video stream, according to an embodiment of the disclosure. The system 100 may include a processor/controller 202, an input/output (I/O) interface 204, one or more modules/units 206, a transceiver 208, and a memory 210. In an example embodiment, the processor/controller 202 may be operatively coupled to each of the I/O interface 204, the modules 206, the transceiver 208, and the memory 210.

In one embodiment, the processor/controller 202 may include at least one data processor for executing processes in the Virtual Storage Area Network. The processor/controller 202 may include specialized processing units such as integrated system (bus) controllers, memory management control units, floating point units, graphics processing units, digital signal processing units, etc. In one embodiment, the processor/controller 202 may include a central processing unit (CPU), a graphics processing unit (GPU), or both. The processor/controller 202 may be one or more general processors, digital signal processors (DSPs), application-specific integrated circuits (ASIC), field-programmable gate arrays (FPGAs), servers, networks, digital circuits, analog circuits, combinations thereof, or other now known or later developed devices for analyzing and processing data. The processor/controller 202 may execute a software program, such as code generated manually (i.e., programmed) to perform the operation.

The processor/controller 202 may be disposed in communication with one or more I/O devices via the I/O interface 204. The I/O interface 204 may employ communication code-division multiple access (CDMA), high-speed packet access (HSPA+), global system for mobile communications (GSM), long-term evolution (LTE), worldwide interoperability for microwave access (WiMAX), or the like, etc.

Using the I/O interface 204, the system 100 may communicate with one or more I/O devices, specifically, to the user device 102. Other examples of the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc.

The processor/controller 202 may be disposed in communication with a communication network via a network interface. In an embodiment, the network interface may be the I/O interface 204. The network interface may connect to the communication network to enable connection of the system 100 with the outside environment and/or device/system. The network interface may employ connection protocols including, without limitation, direct connect, ethernet (e.g., twisted pair 10/100/1000 base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using wireless application protocol), the internet, etc. Using the network interface and the communication network, the system 100 may communicate with other devices.

In an example embodiment, the processor/controller 202 may be configured to receive one or more image frames 101 corresponding to the video stream from the user device 102. The processor/controller 202 may also be configured to identify an object in focus and a corresponding position based on the received one or more image frames of the video stream. In an example embodiment, the object in focus may correspond to a person in the video stream and may also be referred to as the person in focus. Next, the processor/controller 202 may be configured to identify one or more light characteristics surrounding the identified object in focus to determine a position of at least one light source illuminating the identified object in focus. In one embodiment, the one or more light characteristics may include an intensity and a direction of light on the identified object of focus. In an embodiment, to identify the position of the at least one light source illuminating the identified object in focus, the processor/controller 202 may be configured to scale the identified object in focus based on a reference object stored in a database. Next, the processor/controller 202 may be configured to apply a shape mask on the object in focus based on the reference object. Thereafter, the processor/controller 202 may be configured to normalize at least one frame among the one or more image frames 101 based on the scaled and masked object in focus. The processor/controller 202 may generate a pixel scattering matrix based on the normalized at least one frame, wherein the pixel scattering matrix indicates distribution of the at least one light source illuminating the identified object in focus. Furthermore, the processor/controller 202 may identify the position of the at least one light source illuminating the identified object in focus based on the generated pixel scattering matrix.

The processor/controller 202 may further be configured to identify one or more frame quality features associated with the video stream based at least on the position of the object in focus and the position of the at least one light source. Furthermore, the processor/controller 202 may be configured to determine one or more adjustment parameters corresponding to the one or more frame quality features for generating suggestions for the user to enhance the illumination of the identified object in focus in the video stream. Examples of the one or more frame quality features may include, but are not limited to, a contrast, an intensity, a quality, a direction of a camera device capturing the video stream, and so forth.

In one embodiment, the processor/controller 202 may be configured to receive metadata associated with the video stream. The metadata may indicate the context of the video stream. The metadata may include information such as, but not limited to, the purpose of the video stream, the identity of the user, the relation of the user with another user captured in the video stream, the time of the video stream, and a location of the video stream. Further, the processor/controller 202 may be configured to assign a priority to each of the one or more frame quality features based on the received metadata. Furthermore, the processor/controller 202 may be configured to determine the one or more adjustment parameters to enhance the one or more frame quality features based on the assigned priority of each of the one or more frame quality features. In one embodiment the one or more adjustment parameters may correspond to, a path calibration, a rotation calibration, and a head calibration. The path calibration corresponds to a change in at least one of the longitudinal and latitudinal directions of the camera device 102 capturing the video stream. The rotation calibration corresponds to a degree of horizontal rotation of the camera device 102. Further, a head calibration corresponds to a degree of vertical rotation of the camera device 102.

The processor/controller 202 may also be configured to determine whether the user of a camera device 102 used for capturing the video stream is able to view a display of the camera device 102 based at least on a relative position of the camera device 102 and the object in focus. The processor/controller 202 may be configured to display the generated suggestions on a display interface associated with the camera device 102 upon determining that the user is able to view the display of the camera device 102. Further, the processor/controller 202 may be configured to generate non-visual indicators corresponding to the generated suggestions upon determining that the user is unable to view the display of the camera device 102. In an embodiment, the non-visual indicators comprise at least one of the tactic feedback and vibration patterns.

The processor/controller 202 may implement various techniques such as, but not limited to, data extraction, artificial intelligence (AI), machine learning (ML), deep learning (DL), and so forth.

In some embodiments, the memory 210 may be communicatively coupled to the at least one processor/controller 202. The memory 210 may be configured to store data, and instructions executable by the at least one processor/controller 202. The memory 210 may communicate via a bus within the system 100. The memory 210 may include, but not limited to, a non-transitory computer-readable storage media, such as various types of volatile and non-volatile storage media including, but not limited to, random access memory (RAM), read-only memory (ROM), programmable read-only memory (PROM), electrically programmable ROM, electrically erasable ROM, flash memory, magnetic tape or disk, optical media, and the like. In one example, the memory 210 may include a cache or random-access memory for the processor/controller 202. In alternative examples, the memory 210 is separate from the processor/controller 202, such as a cache memory of a processor, the system memory, or other memory. The memory 210 may be an external storage device or database for storing data. The memory 210 may be operable to store instructions executable by the processor/controller 202. The functions, acts, or tasks illustrated in the figures or described may be performed by the programmed processor/controller 202 for executing the instructions stored in the memory 210. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the modules/units 206 may be included within the memory 210. The memory 210 may further include a database 212 to store data. In an embodiment, the database 212 may correspond to the database including a set of specified objects. The one or more modules/units 206 may include a set of instructions that may be executed to cause the system 100 to perform any one or more of the methods/processes disclosed herein. In an embodiment, the units 104, 106, 108, 110, 112, 114, and 116 (as shown in FIG. 1) may be a part of the modules/units 206. The modules/unit 206 may be configured to perform the operations of the disclosure using the data stored in the database 212. In an embodiment, each or some of the modules/units 206 may be a hardware unit that may be outside the memory 210. Further, the memory 210 may include an operating system 214 for performing one or more tasks of the system 100, as performed by a generic operating system in the communications domain. The transceiver 208 may be configured to receive and/or transmit signals to and from the user device 102 associated with the user. In one embodiment, the database 212 may be configured to store the information as required by the one or more modules/units 206 and the processor/controller 202.

The disclosure contemplates a computer-readable medium that includes instructions or receives and executes instructions responsive to a propagated signal. Further, the instructions may be transmitted or received over the network via a communication port or interface or using a bus. The communication port or interface may be a part of the processor/controller 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection, or may be established wirelessly. Likewise, the additional connections with other components of the system 100 may be physical or may be established wirelessly. The network may alternatively be directly connected to the bus. For the sake of brevity, the architecture, and standard operations of the operating system 214, the memory 210, the database 212, the processor/controller 202, the transceiver 208, and the I/O interface 204 are not discussed in detail.

The one or a plurality of processors control the processing of the input data in accordance with a specified operating rule or AI model stored in the non-volatile memory and the volatile memory. The specified operating rule or artificial intelligence model is provided through training or learning.

Here, being provided through learning means that, by applying a learning technique to a plurality of learning data, a specified operating rule or AI model is made. The learning may be performed in a device itself in which AI according to an embodiment is performed, and/or may be implemented through a separate server/system.

The AI model may consist of a plurality of neural network layers. Each layer has a plurality of weight values and performs a layer operation through the calculation of a previous layer and an operation of a plurality of weights. Examples of neural networks include, but are not limited to, convolutional neural network (CNN), deep neural network (DNN), recurrent neural network (RNN), restricted boltzmann machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in a method for generating suggestions to enhance illumination in a video stream, the method may include using an artificial intelligence model to recommend/execute the plurality of instructions. The processor may perform a pre-processing operation on the data to convert the data into a form appropriate for use as an input for the artificial intelligence model. The artificial intelligence model may be obtained by training. Here, “obtained by training” means that a specified operation rule or artificial intelligence model configured to perform a feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logical reasoning and predicting by determining information and includes, e.g., knowledge-based reasoning, optimization prediction, preference-based planning, or recommendation.

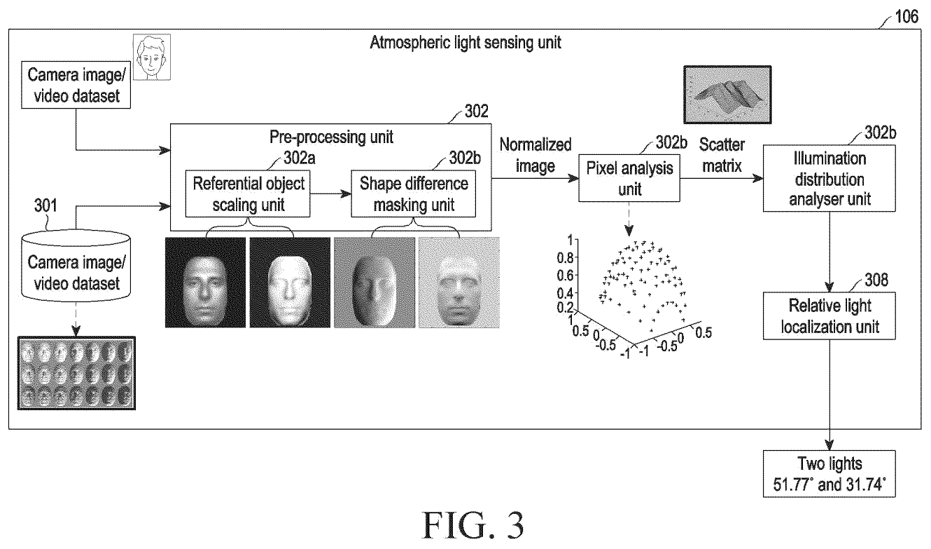

FIG. 3 illustrates a schematic block diagram of the atmospheric light sensing unit 106 of the system 100, according to an embodiment of the disclosure. The atmospheric light sensing unit 106 may be configured to receive a video dataset and/or one or more images from the user device 102. Further, the atmospheric light sensing unit 106 may utilize one or more AI models to identify light characteristics of the one or more light sources that illuminate the surroundings of the object in focus. The video dataset may correspond to the one or more image frames 101. The atmospheric light sensing unit 106 may be configured to process the received video data set to identify one or more light sources illuminating the identified object in focus, as identified by the subject detection unit 104, and corresponding positions.

In an example embodiment, the atmospheric light sensing unit 106 may include a pre-processing unit 302, a pixel analysis unit 304, an illumination distribution analyzer unit 306, and a relative light localization unit 308. The pre-processing 302 may be configured to receive the video dataset as input and generate one or more normalized images corresponding to the received video dataset. In one embodiment, the pre-processing unit 302 may include a referential object scaling unit 302a and a shape difference masking unit 302b. The referential object scaling unit 302a may be configured to process the received input video dataset and/or the one or more image frames and scale the object in focus based on one or more objects received from a reference database 301. The reference database 301 may be a dataset corresponding to a large number of objects captured under different but calibrated light conditions. The reference database 301 enables the atmospheric light sensing unit 106 to reconstruct and relate the object in focus with the dataset of the reference database 301. The pre-processing unit 302 is configured to identify a dataset from the reference database 301 that is similar to the object in focus in the received video data and/or the one or more image frames. In one embodiment, the referential object scaling unit 302a may be configured to scale the received image frame(s) in accordance with the identified dataset from the reference database 301. The referential object scaling unit 302a may be configured to align the size of the received image frame(s) and/or the identified object in focus with the reference object(s) as derived from the reference database 301. The shape difference masking unit 302b is configured to mask the scaled image frame(s) and/or the object in focus to construct a shape corresponding to the object in focus. The shape difference masking unit 302b may be configured to apply a shape mask to the identified object in focus to match with the reference object(s) as derived from the reference database 301. Based on scaling and masking, the pre-processing unit 302 may be configured to generate a normalized image corresponding to the received image frame(s) and/or the video data.

The pixel analysis unit 304 may be configured to take the normalized image from the pre-processing unit 302 as input to generate a corresponding scatter matrix. The scatter matrix (also referred to as scattering matrix) may correspond to a grid of scatter plots that represents the illumination and/or light sourcing illuminating the object in focus. The pixel analysis unit 304 may be configured to analysis each pixel corresponding to the object in focus to identify an illumination intensity on each of different points (facial points) of the object in focus. The scatter matrix may represent said illumination intensities on different points of the object in focus.

The illumination distribution analyzer unit 306 may be configured to further process the generated scatter matrix and identify a distribution of the one or more illumination sources that illuminate the object in focus. The illumination distribution analyzer unit 306 may be configured to generate an illumination spread corresponding to each of the received image frames based on the corresponding scatter matrix to identify the distribution of the one or more illumination sources.

The relative light localization unit 308 may be configured to localize the one or more illumination sources with respect to the identified object in focus. The relative light localization unit 308 may be configured to compare the generated illumination spread with one or more illumination spread corresponding to the reference object(s) as derived from the reference database 301 to identify a position of the one or more illumination source with respect to the object in focus. For instance, in a non-limiting example, the atmospheric light sensing unit 106 identified two illumination/light sources positioned at 51.77° and 31.74° with respect to the identified object in focus.

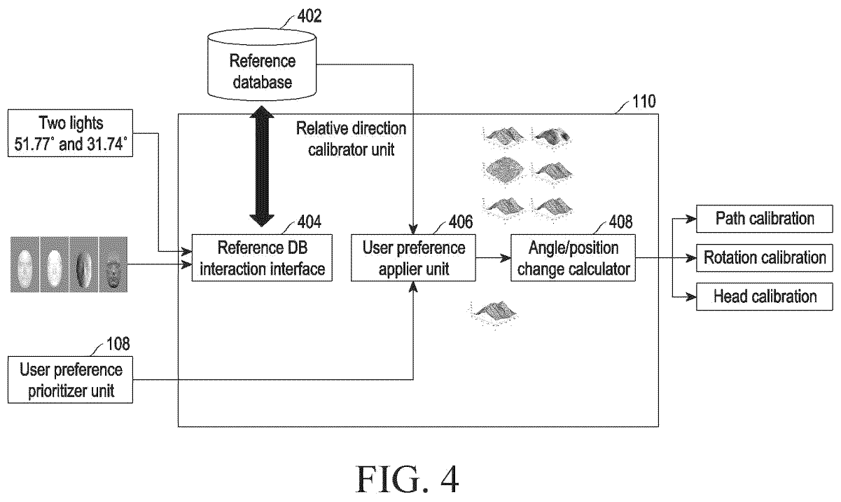

FIG. 4 illustrates a schematic block diagram of the relative direction calibrator unit 110 of the system 100, according to an embodiment of the disclosure. The relative direction calibrator unit 110 may be configured to utilize the information about the object in focus and the one or more light sources of illumination in the surroundings to predict the one or more adjustment parameters which will result in best possible video stream as per the user's preference.

The relative direction calibrator unit 110 may include a reference database (DB) interaction interface 404 configured to interact with the atmospheric light sensing unit 106, and a reference database 402. In one embodiment, the reference database 402 may correspond to the reference database 301. The reference database 402 may include information such as, but not limited to, reference frame data and corresponding light source directions. The reference DB interaction interface 404 may enable communication between the atmospheric light sensing unit 106 and the reference database 402. The reference DB interaction interface 404 may share/store the information corresponding to identified position(s) of the one or more light sources and/or corresponding scaled and masked objects in focus with/at the reference database 402.

Based on the information corresponding to the identified position(s) of the one or more light sources and/or corresponding scaled and masked object in focus, the reference database 402 may share a set of illumination spreads in accordance with the identified position(s) of the one or more light sources to enhance illumination of the object in focus with respect to different frame quality features, with a user preference applier unit 406. For example, an illumination spread may correspond to an enhancement of the intensity of light source(s), and another illumination spread may correspond to an enhancement of a contrast of the object in focus.

The user preference applier unit 406 may communicate with the user preference prioritizer unit 108 to receive a set of frame quality features with corresponding priorities based on the user's preference. The user preference applier unit 406 may select at least one illumination spread from the set of illumination spreads shared by the reference database 402 in accordance with the set of frame quality features and corresponding priorities, as received from the user preference prioritizer unit 108. For instance, if the contrast has been given the highest priority as per user's preference, the user preference applier unit 406 may select the illumination spread that corresponds to the enhancement of the contrast of the object in focus.

The relative direction calibrator unit 110 may also include an angle/position change calculator 408 that may be configured to receive the selected illumination spread as input, and identify a required change in path, twist (in hand), and tilt (in hand) based on a comparison of the illumination spread of the received image frame and the selected illumination spread. The angle/position change calculator 408 may be configured to determine the required change in path, twist (in hand), and tilt (in hand) based on a current position of the object in focus and a required angle to achieve the selected illumination spread.

In an embodiment, the angle/position change calculator 408 may be configured to determine one or more path calibration parameters that correspond to a change in hand position of the user capturing the video stream, one or more rotation parameters that correspond to a change in rotation of the user device 102 within a hand of the user, and one or more head calibration parameters that correspond to a change in tilt of the user device 102 within the hand of the user.

Thus, the relative direction calibrator unit 110 effectively utilizes all the image feature changes that may be sensitive to the lighting conditions.

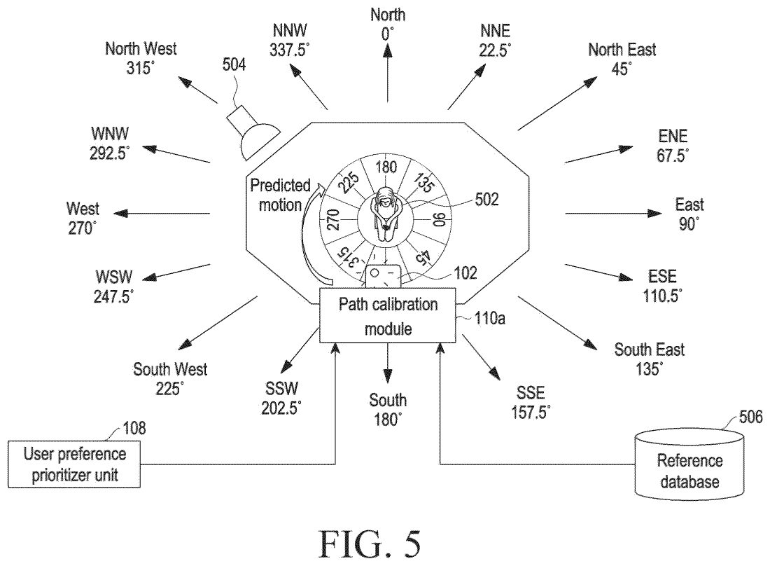

FIG. 5 illustrates an operation of a path calibration module 110a of the relative direction calibrator unit 110, according to an embodiment of the disclosure. In the illustrated embodiment, 502 may represent the identified object in focus in the video stream, and 504 may represent the identified light source and the corresponding position with respect to the identified object in focus. The operation of the path calibration module 110a may initiate with receiving one or more frame quality features and the corresponding priority desired by the user. The user preference prioritizer unit 108 may be configured to receive the metadata associated with the video stream as input and prioritize an order of frame quality features in accordance with the metadata and/or user's preference. The path calibration module 110a may identify a relative position of the object in focus 502, the user device 102, and the light source 504, and compare the identified the image frame and/or the object in focus with one or more objects and corresponding characteristics as stored in a reference database 506. The reference database 506 may correspond to the reference database 301 and/or the reference database 402. The path calibration module 110a may predict the motion of the hand of the user holding the user device 102 in a longitudinal and/or latitudinal direction based on said comparison to enhance the video stream in accordance with the frame quality features and corresponding priority.

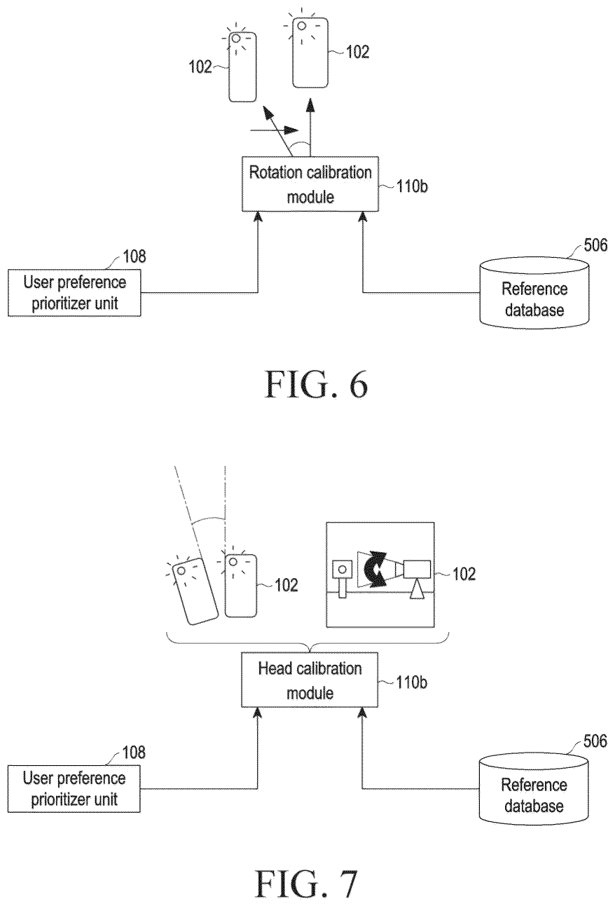

FIG. 6 illustrates an operation of a rotation calibration module 110b of the relative direction calibrator unit 110, according to an embodiment of the disclosure. The rotation calibration module 110b may also operate in conjunction with the user preference prioritizer unit 108 and/or the reference database 506. The rotation calibration module 110b may be configured to predict a degree of horizontal rotation of the user device 102, as shown in FIG. 6. The rotation calibration module 110b may be configured to identify a current position of the user device 102 and/or a required change in angle of rotation of the user device 102 in accordance with the one or more frame quality features and corresponding priorities, as identified by the user preference prioritizer unit 108.

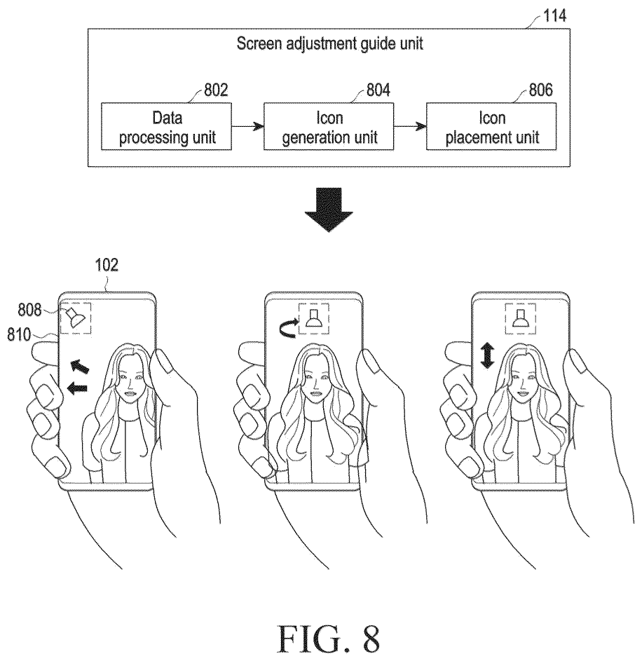

FIG. 7 illustrates an operation of a head calibration module 110c of the relative direction calibrator unit 110, according to an embodiment of the disclosure. The head calibration module 110c may also operate in conjunction with the user preference prioritizer unit 108 and/or the reference database 506. The head calibration module 110b may be configured to predict a degree of vertical rotation of the user device 102, as shown in FIG. 7. The head calibration module 110c may be configured to identify a current position of the user device 102 and/or a required change in angle of head tilt in accordance with the one or more frame quality features and corresponding priorities, as identified by the user preference prioritizer unit 108.

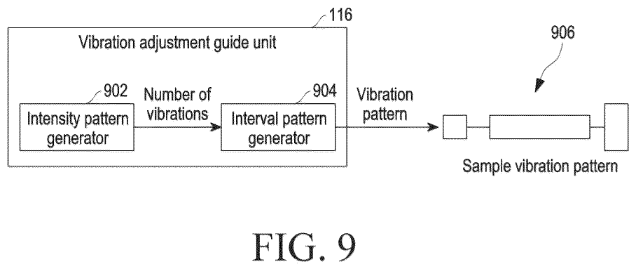

FIG. 8 illustrates a schematic block diagram of the screen adjustment guide unit 114 of the system 100, according to an embodiment of the disclosure. In an embodiment, upon determining that the user capturing the video stream may view the display screen of the camera device/user device 102, the user adjustment guide unit 112 may share the one or more adjustment parameters with the screen adjustment guide unit 114 to generate the suggestions for the user. The screen adjustment guide unit 114 may include a data processing unit 802, an icon generation unit 804, and an icon placement unit 806. The data processing unit 802 may be configured to process the received information which may include the position of the one or more light sources, the position of the object in focus, and/or the one or more adjustment parameters to remove any ambiguity and/or redundant information. The data processing unit 802 may configured to share the processed information with the icon generation unit 804. The icon generation unit 804 may be configured to generate one or more icons (i.e., graphical representations) of at least one of the light sources, the object in focus, and the one or more adjustment parameters. The icon placement unit 806 may identify a position on the display screen of the user device 102 to place the generated one or more icons such that the desired intent of the system 100 is effectively communicated to the user. For instance, the icon generation unit 804 may generate an icon 808 for the light source, and one or more icons 810 for the one or more adjustment parameters. Further, the icon placement unit 806 may place the icon 808 in accordance with the identified position of the corresponding light source, and the icon(s) 810 such that the user may effectively implement the suggested adjustments to enhance the video stream. The icon(s) generated by the icon generation unit 808 may be a part of the UI that may be displayed over the display screen of the user device 102.

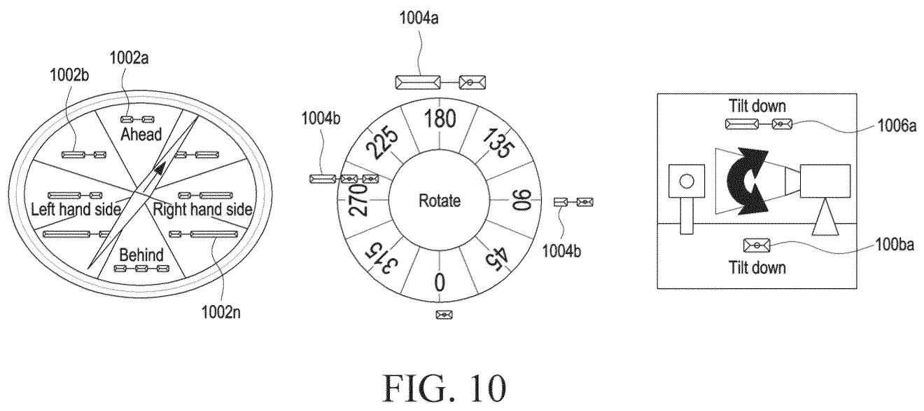

FIG. 9 illustrates a schematic block diagram of the vibration adjustment guide unit 116 of the system 100, according to an embodiment of the disclosure. In an embodiment, upon determining that the user capturing the video stream cannot view the display screen of the camera device/user device 102, the user adjustment guide unit 112 may share the one or more adjustment parameters with the vibration adjustment guide unit 116 to generate the suggestions for the user. The vibration adjustment guide unit 116 may be configured to generate non-visual indicators such as, vibration patterns and/or tactic feedback, for the user to provide the generated suggestions. The vibration adjustment guide unit 116 may be configured to receive the one or more adjustment parameters from the user adjustment guide unit 112 as input to generate vibration parameters like displacement, velocity, and acceleration. The vibration adjustment guide unit 116 may generate the vibration parameters in such a manner that the adjustment parameters may be easily conveyed to the user to enhance the video stream.

The vibration adjustment guide unit 116 may include an intensity pattern generator 902 and an interval pattern generator 904. The intensity pattern generator 902 may be configured to define an intensity in terms of the amplitude and number of the vibrations. The intensity pattern generator 902 may define whether the vibration should be weak, strong, and/or moderate based on the one or more adjustment parameters. Further, the intensity pattern generator 902 may also define the number of vibrations required to effectively convey the one or more adjustment parameters to the user. In an example embodiment, the intensity pattern generator 902 may operate a motor (i.e., the vibration motor) of the user device 102 in such a manner that the desired vibrations may be generated and conveyed to the user. In one embodiment, the intensity pattern generator 902 may control a power supplied to the vibration motor of the user device 102 to generate the vibrations of the different intensities. For example, the intensity pattern generator 902 may supply a high power supply to generate the vibration patterns of the high intensity. Similarly, the intensity pattern generator 902 may power-on and power-off the power supply to the vibration motor of the user device 102 to control the number of vibrations.

The interval pattern generator 904 may be configured to define a gap between two consecutive vibrations based on the one or more adjustment parameters. In an embodiment, the interval pattern generator 904 may define a time gap (such as 100 ms, 230 ms, 370 ms, 500 ms, etc.) between the power-on and power-off cycle of the vibration motor of the user device 102. In a non-limiting example, the vibration adjustment guide unit 116 may generate a vibration pattern 906. In an embodiment, a thickness of each block of the vibration pattern 906 may indicate the intensity of the vibration pattern, the number of blocks may correspond to the number of vibrations, and a space between two consecutive blocks may indicate an interval between two vibrations.

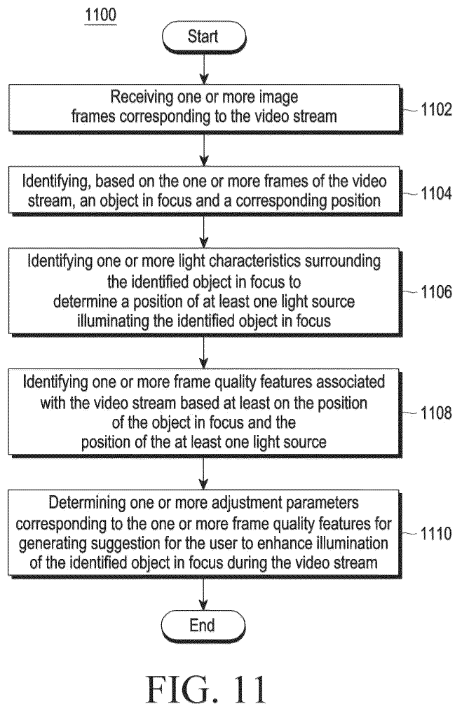

FIG. 10 illustrates some example vibration patterns corresponding to different adjustment parameters, as generated by the vibration adjustment guide unit 116, according to one or more embodiments of the disclosure. For instance, the vibration patterns 1002 may correspond to the path calibration adjustment parameters, the vibration patterns 1004 may correspond to the rotation calibration adjustment parameters, and the vibration patterns 1006 may correspond to the head calibration adjustment parameters. The vibration patterns 1002 (including patterns 1002a-1002n) may correspond to the path calibration, as discussed above. For instance, in case the system 100 generates a suggestion for the user guiding the user to move ahead, or to take the user device 102 closer to the object in focus, the vibration adjustment guide unit 116 may generate the vibration pattern 1002a that indicates two equal intensity vibrations with a short interval. Similarly, the vibration adjustment guide unit 116 may generate other vibration patterns in accordance with the adjustment parameters. Further, the vibration patterns 1004 (including patterns 1004a-1004n) may correspond to the rotation calibration, and the vibration patterns 1006 (including patterns 1006a-1006b) may correspond to the tilt calibration, as discussed above, in reference to FIGS. 1-9. In some embodiments, the user may be trained using the said specified vibration patterns 1002, 1004, and 1006 such that the user may effectively understand the vibration patterns and make the suggested adjustments.

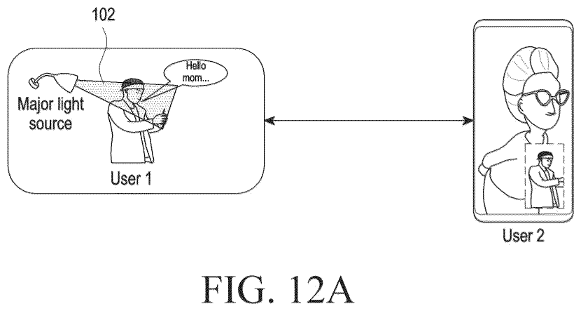

FIG. 11 illustrates a flow chart of a method 1100 for generating suggestions to enhance illumination in the video stream, according to an embodiment of the disclosure. The method 1100 may be implemented by the one or more components of the system 100.

At operation 1102, the method 1100 may include receiving one or more image frames 101 corresponding to the video stream.

At operation 1104, the method 1100 may include identifying, based on the one or more image frames 101 of the video stream, an object in focus and a corresponding position.

At operation 1106, the method 1100 may include identifying one or more light characteristics surrounding the identified object in focus to determine a position of at least one light source illuminating the identified object in focus.

At operation 1108, the method 1100 may include identifying one or more frame quality features associated with the video stream based at least on the position of the object in focus and the position of the at least one light source.

At operation 1010, the method 1600 may include determining one or more adjustment parameters corresponding to the one or more frame quality features for generating suggestions for the user to enhance illumination of the identified object in focus in the video stream.

Embodiments as discussed above are examples and the method 1100 may include any additional operation. Further, the operations of the method 1100 may be performed in any suitable manner.

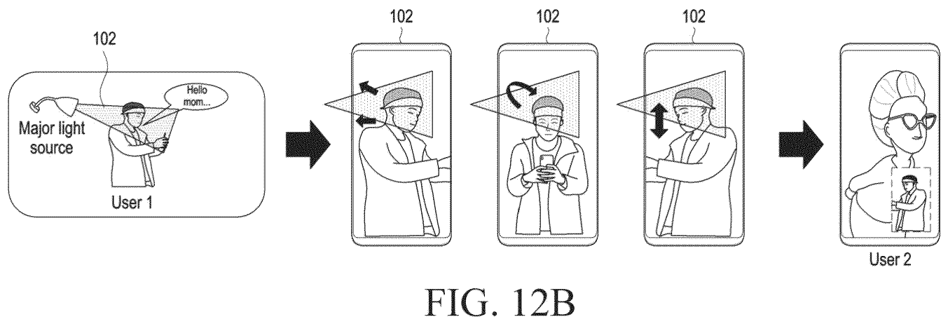

FIGS. 12A and 12B illustrate an example scenario of the implementation of the system during a video call, according to one or more embodiments of the disclosure. FIG. 12A illustrates a scenario when a “user 1” is engaged with a “user 2” in a video calling session. However, due to the bad positioning of the “user 1” and an associated user device/camera device with respect to a light source in the environment of the user, the “user 2” is getting a poor video stream of the “user 1”. For instance, a major light source is positioned directly in front of the camera device/user device, and at the back side of the “user 1”.

Thus, the “user 1” and “user 2” may bad user experience during said video calling session. In related art video streaming solutions, there does not exist any suitable mechanism to suggest/inform the “user 1” on how to correct an angle of the camera device/user device, and/or a hand position to improve a quality of the video stream.

FIG. 12B illustrates implemented of the system 100 in the scenario illustrated in FIG. 12B. Specifically, the system 100 may extract information such as, the position of “the user 1”, the position of the camera device/user device associated with the “user 1”, and atmospheric light conditions along with the position of the light sources illuminating the “user 1”. Further, based on the relative positions of the camera device/user device, the user, and the major light source, the system 100 provides the “user 1” with an adjustment guide via one or more UIs to improve the lighting condition of the video call, as illustrated in FIG. 12B. As the “user 1” follows the provided adjustment guide, the quality of the video stream improves, and the “user 1” and “user 2” may have a good user experience.

In a scenario, where three users namely a “user A”, a “user B”, and a “user C” are engaged in a video call session, where the “user B” and “user C” is talking during the video call session being conducted using a front camera of the camera device/user device of “user A”. Further, the “user A” is holding the camera device/user device in such as a manner that a display screen of the camera device/user device is not visible the “user A”, instead is facing “user B” who is sitting a distance from the camera device/user device. Furthermore, the “user C” is unable to properly see the “user B” due to poor lighting conditions. In such a scenario, the system 100 may generate and share the adjustment guide with the “user A” via the one or more non-visual indicators such as, vibration patterns. The “user A” may analyze the vibration patterns and adjust the position of the camera device/user device, hand, and/or head to enhance the quality of the video stream being projected at a display screen of a user device associated with the “user C”.

The system 100 may also be implemented during an avatar generation in a metaverse environment. While generating the avatar in the metaverse environment, the system 100 identified that the user is in poor lighting conditions and the generated avatar is affected by said poor lighting conditions, the system 100 may generate and provide an adjustment guide to the user to position himself/herself in a better lighting condition. This improves a quality of the generated avatar and user experience with the metaverse environment.

Thus, the disclosure helps the user to generate good-quality video frames by effectively using the camera device without any intervention with frame data. Therefore, the solution of the disclosure is effective and efficient during a live video session/video call. The solution of the disclosure suggests the user change a position in such a way that illumination distribution around the user is perfectly aligned with the angle of the camera device. Therefore, the solution of the disclosure prevents any additional delay or lag during the video stream. Furthermore, the solution of the disclosure is implemented using minimal resource requirements.

While specific language has been used to describe the subject matter, any limitations arising on account thereto, are not intended. As would be apparent to a person in the art, various working modifications may be made to the method in order to implement embodiments as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for generating suggestions to enhance illumination in a video stream, the method comprising:
receiving one or more image frames corresponding to the video stream;
identifying, based on the one or more image frames corresponding to the video stream, an object in focus and a position of the object in focus;
identifying a position of at least one light source illuminating the identified object in focus by identifying one or more light characteristics surrounding the object in focus;
identifying one or more frame quality features associated with the video stream based on at least one of the position of the object in focus or the position of the at least one light source; and
identifying one or more adjustment parameters corresponding to the one or more frame quality features for generating suggestions for the user to enhance illumination of the identified object in focus in the video stream.

2. The method as claimed in claim 1, wherein identifying the one or more adjustment parameters corresponding to the one or more frame quality features comprises:
receiving metadata associated with the video stream, wherein the metadata indicates a context of the video stream;
assigning a priority to each of the one or more frame quality features based on the received metadata; and
identifying the one or more adjustment parameters corresponding to the one or more frame quality features based on the assigned priority of each of the one or more frame quality features.

3. The method as claimed in claim 2, wherein the metadata comprises at least one of a purpose of the video stream, an identity of the user, a relation of the user with another user captured in the video stream, a time of the video stream, or a location of the video stream.

4. The method as claimed in claim 1, wherein the one or more frame quality features comprises at least one of a contrast, an intensity, a quality, or a direction of a camera device capturing the video stream.

5. The method as claimed in claim 1, further comprising:
identifying whether the user of a camera device used for capturing the video stream views a display of the camera device based on at least one of a relative position of the camera device or the object in focus;
based on identifying that the user views the display of the camera device, displaying the generated suggestions on a display interface associated with the camera device; and
based on identifying that the user does not view the display of the camera device, generating non-visual indicators corresponding to the generated suggestions.

6. The method as claimed in claim 5, wherein the non-visual indicators comprise at least one of tactic feedbacks or vibration patterns.

7. The method as claimed in claim 1, wherein identifying the position of the at least one light source illuminating the identified object in focus comprises:
scaling the identified object in focus based on a reference object stored in a database;
applying a shape mask on the scaled object in focus based on the reference object;
normalizing at least one frame among the one or more image frames based on the object in focus applied the shape mask;
generating a pixel scattering matrix based on the normalized at least one frame, wherein the pixel scattering matrix indicates distribution of the at least one light source illuminating the identified object in focus; and
identifying the position of the at least one light source illuminating the identified object in focus based on the generated pixel scattering matrix.

8. The method as claimed in claim 1, wherein the one or more adjustment parameters comprises at least one of a path calibration, a rotation calibration, or a head calibration, wherein the path calibration corresponds to a change in at least one of a longitudinal and latitude direction of a camera device capturing the video stream, a rotation calibration corresponds to a degree of horizontal rotation of the camera device, or a head calibration corresponds to a degree of vertical rotation of the camera device.

9. The method as claimed in claim 1, wherein the one or more light characteristics comprises an intensity and a direction of light on the identified object in focus.

10. A system for generating suggestions to enhance illumination in a video stream, the system comprising:
at least one processor; and
memory storing instructions that,
when executed by the at least one processor, cause the system to:
receive one or more image frames corresponding to the video stream;
identify, based on the one or more image frames corresponding to the video stream, an object in focus and a position of the object in focus;
identify a position of at least one light source illuminating the identified object in focus by identifying one or more light characteristics surrounding the identified object in focus;
identify one or more frame quality features associated with the video stream based on at least one of the position of the object in focus or the position of the at least one light source; and
identify one or more adjustment parameters corresponding to the one or more frame quality features for generating suggestions for the user to enhance illumination of the identified object in focus in the video stream.

11. The system as claimed in claim 10, wherein identifying the one or more adjustment parameters corresponding to the one or more frame quality features, the instructions, when executed by the at least one processor, cause the system to:
receive metadata associated with the video stream, wherein the metadata indicates a context of the video stream;
assign a priority to each of the one or more frame quality features based on the received metadata; and
identify the one or more adjustment parameters corresponding to the one or more frame quality features based on the assigned priority of each of the one or more frame quality features.

12. The system as claimed in claim 11, wherein the metadata comprises at least one of a purpose of the video stream, an identity of the user, a relation of the user with another user captured in the video stream, a time of the video stream, and a location of the video stream.

13. The system as claimed in claim 10, wherein the one or more frame quality features comprises at least one of a contrast, an intensity, a quality, or a direction of a camera device capturing the video stream.

14. The system as claimed in claim 10, wherein the instructions, when executed by the at least one processor, cause the system to:
identify whether the user of a camera device used for capturing the video stream views a display of the camera device based on at least one of a relative position of the camera device or the object in focus;
based on identifying that the user views the display of the camera device, display the generated suggestions on a display interface associated with the camera device; and
based on identifying that the user does not view the display of the camera device, generate non-visual indicators corresponding to the generated suggestions.

15. The system as claimed in claim 14, wherein the non-visual indicators comprise at least one of tactic feedbacks or vibration patterns.

16. The system as claimed in claim 10, wherein to identify the position of the at least one light source illuminating the identified object in focus, the instructions, when executed by the at least one processor, cause the system to:
scale the identified object in focus based on a reference object stored in a database;
apply a shape mask on the scaled object in focus based on the reference object;
normalize at least one frame among the one or more image frames based on the object in focus applied the shape mask;
generate a pixel scattering matrix based on the normalized at least one frame, wherein the pixel scattering matrix indicates distribution of the at least one light source illuminating the identified object in focus; and
identify the position of the at least one light source illuminating the identified object in focus based on the generated pixel scattering matrix.

17. The system as claimed in claim 10, wherein the one or more adjustment parameters comprises at least one of a path calibration, a rotation calibration, or a head calibration, wherein the path calibration corresponds to a change in at least one of a longitudinal and latitude direction of a camera device capturing the video stream, a rotation calibration corresponds to a degree of horizontal rotation of the camera device, or a head calibration corresponds to a degree of vertical rotation of the camera device.

18. The system as claimed in claim 10, wherein the one or more light characteristics comprises an intensity and a direction of light on the identified object in focus.

19. One or more non-transitory computer-readable storage media storing one or more computer programs including computer-executable instructions that, when executed by at least one processor, cause a system to perform operations, the operations comprising:
receiving one or more image frames corresponding to the video stream;
identifying, based on the one or more image frames corresponding to the video stream, an object in focus and a position of the object in focus;
identifying a position of at least one light source illuminating the identified object in focus by identifying one or more light characteristics surrounding the object in focus;
identifying one or more frame quality features associated with the video stream based on at least one of the position of the object in focus or the position of the at least one light source; and
identifying one or more adjustment parameters corresponding to the one or more frame quality features for generating suggestions for the user to enhance illumination of the identified object in focus in the video stream.
